(19) United States
(12) Patent Application Publication
(10) Pub. No.: US 2020/0073333 A1
(43) Pub. Date: Mar. 5, 2020

(54) ADJUSTABLE HOURGLASS WITH RESET FUNCTION

(71) Applicant: BestSelf Ventures, LLC, Austin, TX (US)

(72) Inventors: Cathryn Lavery, Long Island City, NY (US); Allen Brouwer, Forked River, NJ (US)

(21) Appl. No.: 16/541,189

(22) Filed: Aug. 15, 2019

Related U.S. Application Data
(60) Provisional application No. 62/724,635, filed on Aug. 30, 2018.

(51) Int. Cl. G04F 1/06

(52) U.S. Cl. CPC G04F 1/06

(57) ABSTRACT

An hourglass assembly and a method for producing an hourglass assembly are described herein. The hourglass assembly may include a first bulb for collecting or releasing granular material, a second bulb for collecting or releasing the granular material, and an adjustable hourglass mechanism coupled with both the first bulb and the second bulb. The adjustable hourglass mechanism may be configured to regulate a speed of passing of the granular material through the adjustable hourglass mechanism from the first bulb to the second bulb or vice versa.

### CROSS-REFERENCE TO RELATED APPLICATIONS

This application claims priority of U.S. Provisional Patent Application No. 62/724,635 filed on Aug. 30, 2019, entitled “ADJUSTABLE HOURGLASS WITH RESET FUNCTION,” which is incorporated herein by reference in its entirety.

### BACKGROUND

### Technical Field

This disclosure generally relates to hourglasses (sandglasses). More particularly, this disclosure relates to an adjustable hourglass assembly that provides multiple timing functions and a reset function.

### Description of Related Art

An hourglass is a device designed to measure passage of time. A conventional hourglass comprises two glass bulbs connected vertically by a narrow neck which allows trickling of granular material (e.g., sand) from the upper bulb to the lower bulb. When the entire material has passed through the neck, a user can flip the hourglass to start measuring another time cycle. However, the conventional hourglass is designed to measure one predetermined period of time. When a user needs to measure different periods of time, different hourglasses are needed. In other words, the conventional hourglass provides one timing function per device. Another disadvantage of the conventional hourglass is the lack of a reset functionality to allow for quick passage of the material from one bulb to the other.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

According to one aspect of this disclosure, there is provided an hourglass assembly. An example hourglass assembly may include a first bulb for collecting or releasing granular material (e.g., sand), a second bulb for collecting or releasing the granular material, and an adjustable hourglass mechanism coupled with both the first bulb and the second bulb. The adjustable hourglass mechanism may be configured to regulate a speed of passing of the granular material through the adjustable hourglass mechanism from the first bulb to the second bulb or vice versa.

According to another aspect of this disclosure, a method for producing an hourglass assembly is provided, in accordance with an example embodiment. The method may include providing a first bulb for collecting or releasing a granular material at operation and providing a second bulb for collecting or releasing the granular material. The method may further include connecting an adjustable hourglass mechanism directly to both the first bulb and the second bulb. The adjustable hourglass mechanism may be configured to regulate a speed of passing of the granular material through the adjustable hourglass mechanism from the first bulb to the second bulb or from the second bulb to the first bulb.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1 shows a simplified front view of an hourglass assembly, according to one example embodiment.

FIG. 2 shows an isometric, cross-sectional, and partial view of an adjustable hourglass mechanism, according to one example embodiment.

FIG. 3 shows a front cross-sectional view of an adjustable hourglass mechanism, according to one example embodiment.

FIG. 4 is an isometric view of an assembly of a first casing, a second casing, and a rotating disc, according to one example embodiment.

FIG. 5 is an isometric view of a rotating disc, according to one example embodiment.

FIG. 6 is a top view of a rotating disc, according to one example embodiment.

FIGS. 7A-7D are schematic diagrams showing switching between positions of a rotating disc inside an adjustable hourglass mechanism, according to an example embodiment.

FIG. 8 is a flow chart illustrating a method for producing an hourglass assembly, in accordance with an example embodiment.

### DETAILED DESCRIPTION OF EXAMPLE EMBODIMENTS

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Aspects of the embodiments will now be presented with reference to an hourglass assembly. For purposes of this patent document, the terms “hourglass,” “hourglass assembly,” “sand clock,” “sand timer,” and “sandglass” are interchangeable and have the same meaning.

Furthermore, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

It should be also understood that the terms “first,” “second,” “third,” and so forth can be used herein to describe various elements. These terms are used to distinguish one element from another, but not to imply a required sequence of elements. For example, a first element can be termed a second element, and, similarly, a second element can be termed a first element, without departing from the scope of present teachings.

Moreover, it shall be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” and so forth). Spatially relative terms, such as “beneath,” “below,” “lower,” “above,” “upper” and the like may be used to describe an element or feature's relationship to another element(s) and/or feature(s) as, for example, illustrated in the drawings. It shall be appreciated the spatially relative terms are intended to encompass different orientations of the hourglass or its elements in use in addition to the orientation depicted in the figures. For example, if the hourglass or any of its components in the drawings is turned over, elements described as “below” and/or “beneath” other elements or features would then be oriented “above” the other elements or features. The hourglass or its components may be otherwise oriented (e.g., rotated 90 degrees or at other orientations) and the spatially relative descriptors used herein interpreted accordingly.

Now, exemplary embodiments are described with reference to the drawings. The drawings are schematic illustrations of idealized example embodiments. As such, variations from the shapes of the illustrations as a result, for example, of manufacturing techniques or tolerances, are to be expected. Thus, example embodiments discussed herein should not be construed as limited to the particular shapes of regions illustrated herein but are to include deviations in shapes that result, for example, from manufacturing.

The present disclosure relates to an hourglass assembly. The hourglass assembly may include a first bulb for collecting or releasing granular material, a second bulb for collecting or releasing the granular material, and an adjustable hourglass mechanism coupled with both the first bulb and the second bulb. The adjustable hourglass mechanism may be configured to regulate a speed of passing of the granular material through the adjustable hourglass mechanism from the first bulb to the second bulb, or vice versa.

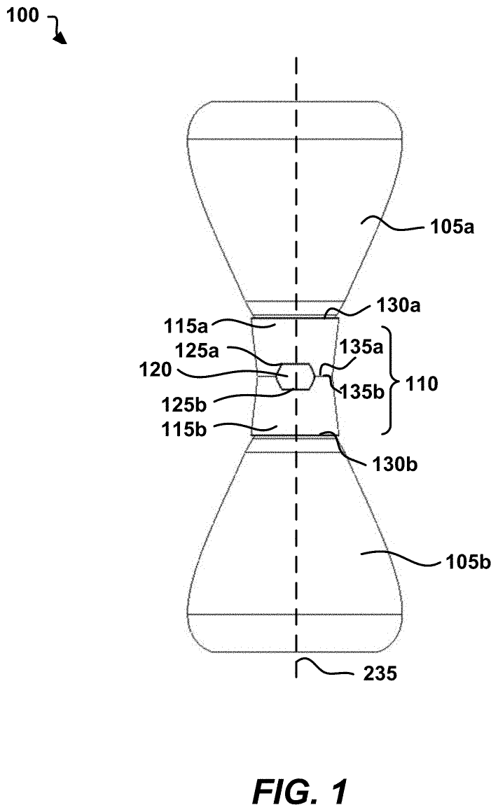

FIG. 1 shows a simplified front view of an hourglass assembly 100, according to one example embodiment. As shown, hourglass assembly 100 includes a first bulb 105a and a second bulb 105b, which can be arranged symmetrically and opposite each other so that a reference axis of first bulb 105a and a reference axis of second bulb 105b coincide. The reference axis of first bulb 105a and second bulb 105b is shown as a reference axis 235. First bulb 105a and second bulb 105b can be of any suitable transparent or semi-transparent material, including, without limitation, a glass or polymer. Each of first bulb 105a and second bulb 105b includes an internal space designed to collect, store, and release granular material. The “granular material” may refer to sand or any other natural or synthetic material of suitable properties. Each of first bulb 105a and second bulb 105b also includes an aperture for receiving or releasing the granular material. When first bulb 105a and second bulb 105b are held vertically, the gravity forces the granular material to flow from first bulb 105a to second bulb 105b.

As shown in FIG. 1, first bulb 105a is connected to second bulb 105b via an adjustable hourglass mechanism 110, which is configured to control the speed of flow of the granular material from first bulb 105a to second bulb 105b when the hourglass assembly 100 is disposed so that first bulb 105a is positioned above second bulb 105b, or vice versa when the hourglass assembly 100 is disposed so that second bulb 105b is positioned above first bulb 105a. The control can be carried out manually by a user. This structure of hourglass assembly 100 requires no external power source for any of its functions.

Adjustable hourglass mechanism 110 includes a first bulb holder 115a for holding first bulb 105a and a second bulb holder 115b for holding second bulb 105b. First bulb holder 115a has a first end 130a configured to connect with first bulb 105a and a second end 135a configured to connect with second bulb holder 115b. Second bulb holder 115b has a first end 130b configured to connect with second bulb 105b and a second end 135b configured to connect with second end 135b of first bulb holder 115a.

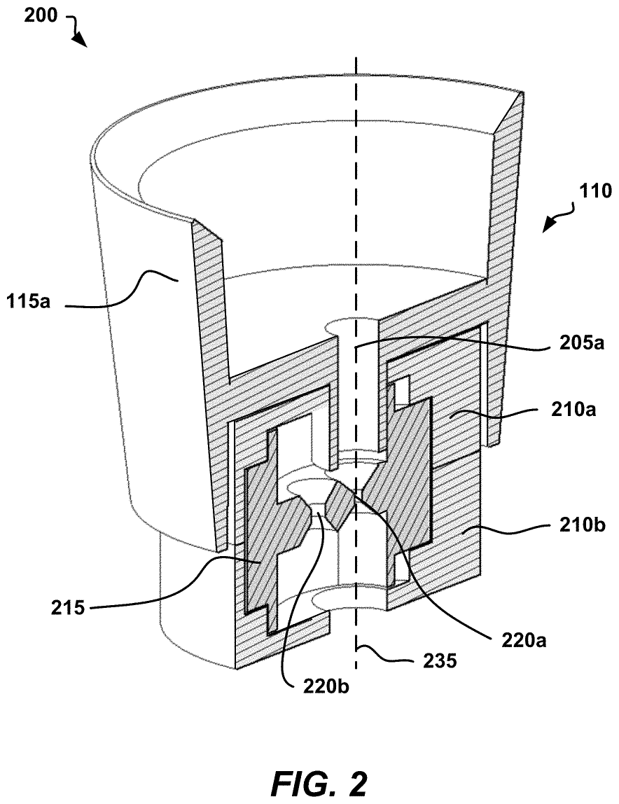

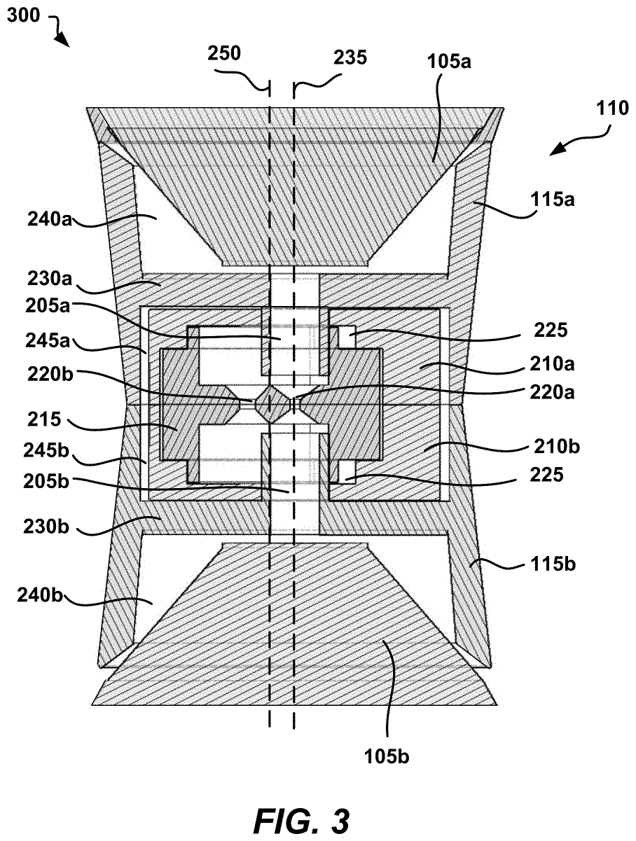

There is also provided a dial 120 integrated with adjustable hourglass mechanism 110 to enable the user to control the speed of passing of the granular material through hourglass mechanism 110, and, thereby, enabling the user to select a desired timing or a “reset” function (option). Specifically, first bulb holder 115a may have a recess 125a and second bulb holder 115b may have a recess 125b. Dial 120 may protrude outwards toward an opening created by recess 125a and recess 125b. Specifically, dial 120 is a portion of a rotating disc (described below with reference to FIGS. 2 and 3) that is disposed inside adjustable hourglass mechanism 110 and projects outwards through recess 125a and recess 125b.

FIG. 2 shows an isometric, cross-sectional, and partial view 200 of adjustable hourglass mechanism 110, according to one example embodiment. FIG. 3 shows a front cross-sectional view 300 of adjustable hourglass mechanism 110, according to one example embodiment.

FIG. 2 and FIG. 3 illustrate the structure of first bulb holder 115a and second bulb holder 115b. First bulb holder 115a and second bulb holder 115b may have identical structures and be symmetrically positioned to face each other. First bulb holder 115a has first side walls and a first internal wall arranged perpendicular to the first side walls. Second bulb holder 115b has second side walls and a second internal wall arranged perpendicular to the second side walls. Specifically, each of first bulb holder 115a and second bulb holder 115b has a cylindrical shape or a hollow flattened cone shape, including an internal wall 230a (first internal wall) and 230b (second internal wall), respectively, arranged perpendicularly to side walls or a reference axis of each of first bulb holder 115a and second bulb holder 115b. First bulb holder 115a and second bulb holder 115b have the same reference axis. A reference axis 235 of first bulb 105a and second bulb 105b coincides with the reference axis of first bulb holder 115a and second bulb holder 115b. The reference axis 235 also denotes the reference axis of first bulb holder 115a and second bulb holder 115b.

The internal walls 230a and 230b of first bulb holder 115a and second bulb holder 115b, respectively, have channels 205a, 205b, respectively, that extend through internal walls 230a and 230b and allow passing of the granular material. One hollow section 240a of first bulb holder 115a and one hollow section 240b of second bulb holder 115b are designed to receive first bulb 105a and second bulb 105b, respectively. First bulb 105a can be secured within first bulb holder 115a and second bulb 105b can be secured within second bulb holder 115b (for example, glued or welded). The other (opposite) hollow section 245a of first bulb holder 115a and the other (opposite) hollow section 245b of second bulb holder 115b are designed to receive and hold a first casing 210a and a second casing 210b, respectively. First casing 210a and second casing 210b are symmetrical and include an internal space 225 for arranging a rotating disc 215. Rotating disc 215 may be located between internal wall 230a of first bulb holder 115a and internal wall 230b of second bulb holder 115b. First casing 210a and second casing 210b symmetrically face each other and enclose rotating disc 215 between internal wall 230a and internal wall 230b. Specifically, first casing 210a may be located between internal wall 230a of first bulb holder 115a and rotating disc 215. Second casing 210b may be located between internal wall 230b of second bulb holder 115b and rotating disc 215. First casing 210a, second casing 210b, first bulb holder 115a, second first bulb holder 115b, and rotating disc 215 can be made of any suitable material, including, without limitation, polymers, wood, metal, or any combination thereof.

Rotating disc 215 includes a plurality of through holes for passing the granular material from the first bulb via channel 205a to the second bulb via channel 205b, or vice versa. For example, there can be provided at least a first through hole 220a and a second through hole 220b. First through hole 220a of the plurality of through holes is configured to be positioned in line with channel 205a and channel 205b (i.e., under channel 205a and over channel 205b, or vice versa). Rotating disc 215 is designed to be rotated within the internal space 225 in response to user's control of dial 120. Specifically, rotating disc 215 is configured to rotate around a reference axis 250 of rotating disc 215 in response to applying a sideward force by a user to the portion of the rotating disc that projects outwards through a recess of first bulb holder 115a and second bulb holder 115b (i.e., applying the sideward force to dial 120 shown in FIG. 1). Second through hole 220b of the plurality of holes is configured to move to be positioned in line with channel 205a and channel 205b (i.e., under channel 205a and over channel 205b, or vice versa) in response to the rotation of rotating disc 215 around the reference axis of rotating disc 215. The through holes can be of different diameters and selectively positioned between channels 205a, 205b in order to enable the user to select a desired timing or the reset function. A diameter of one of the plurality of through holes may be equal to an inner diameter of channel 205a and channel 205b. A diameter of each further through hole of the plurality of through holes may be smaller than the inner diameter of channel 205a and channel 205b. In other words, by selecting a desired through hole (i.e., a through hole having a particular diameter), the user can select the predetermined amount of time needed to pass the entire granular material from one bulb to the other (e.g., 15 minutes, 30 minutes, 45 minutes, etc.). The number of timing functions is only limited by the available space inside hourglass mechanism 110 and a number of through holes. This structure can be scaled to allow for as many timing options as required by the application of the hourglass assembly. The size of the through hole is determined by finding a flow rate based on the granular material size, such as, for example, 1 gram per minute through a 2-millimeter diameter through hole. Using this approach, it is possible to create custom timing options (functions) per application.

Adjustable hourglass mechanism 110 utilizes an open structure that uses guiding channels 205a, 205b to allow the granular material (e.g., sand) to flow through without escaping from hourglass mechanism 110. This open structure provides for simple manufacturing and assembly. A reference axis 250 of rotating disc 215 is offset with respect to reference axis 235 of first bulb 105a and second bulb 105b. In view of displacement of reference axis 250 with respect to reference axis 235, a portion of rotating disc 215 protrudes through recess 125a of first bulb holder 115a and recess 125b of second bulb holder 115b (as shown in FIG. 1). Each of first casing 210a and second casing 210b may have similar recesses to allow the portion of rotating disc 215 to protrude outwards first casing 210a and second casing 210b and outwards first bulb holder 115a and second bulb holder 115b. The protruding portion of the rotating disc 215 can be accessed by the user and is also referred herein to as dial 120. In other words, dial 120 (see FIG. 1) protrudes from adjustable hourglass mechanism 110 to allow for user control of the selectable operational modes (“timing functions”). Adjustable hourglass mechanism 110 can also be indexed in order to allow the user to quickly select the chosen time setting. Specifically, a number of indexes may be placed on dial 120 and/or first bulb holder 115a and second bulb holder 115b. Each of the indexes may indicate a time setting that corresponds to the current position of dial 120 in adjustable hourglass mechanism 110. The time setting is selected by the user rotating disc 215 so as to place a particular through hole of rotating disc 215 between channel 205a and channel 205b of first bulb holder 115a and second bulb holder 115b, respectively.

In order to provide the “reset” function, adjustable hourglass mechanism 110 may be sufficiently large to allow an uninterrupted flow of sand from first bulb 105a to second bulb 105b or vice versa. The “reset” function allows for a quick passage of the granular material from first bulb 105a to second bulb 105b, or vice versa, to enable the user to “restart” any desired timing function. To provide the “reset” function, a diameter of one of through holes of rotating disc 215 may be at least equal to an inner diameter of channel 205a and channel 205b of first bulb holder 115a and second bulb holder 115b, respectively. The “reset” function is provided by placing the through hole that has the diameter equal to the inner diameter of channel 205a and channel 205b between channel 205a and channel 205b.

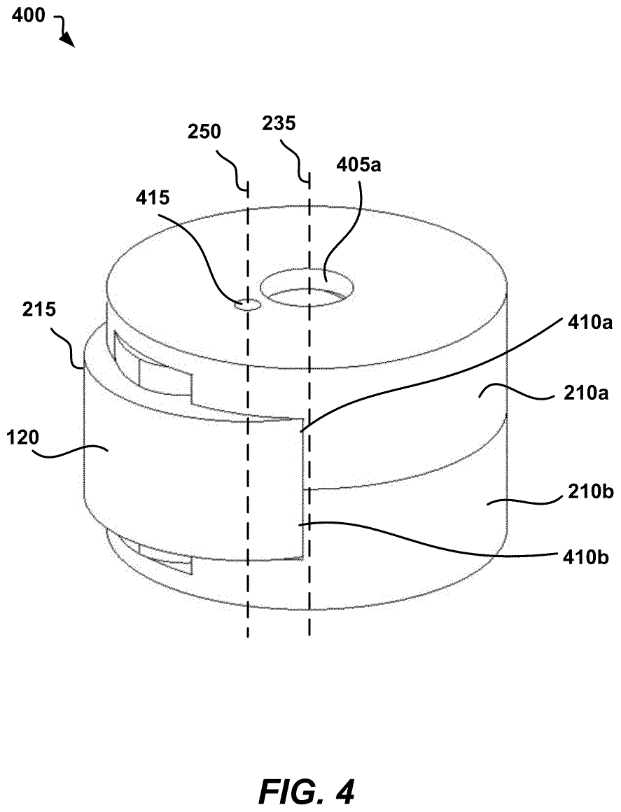

FIG. 4 is an isometric view 400 of an assembly of first casing 210a, second casing 210b, and rotating disc 215 having a dial 120, according to one example embodiment. Isometric view 400 shows that first casing 210a includes an aperture 405a for receiving channel 205a of bulb holder 115a. The same aperture is provided in second casing 210b. Each of first casing 210a and second casing 210b has a recess 410a and 410b, respectively, for enabling dial 120 to extend from first casing 210a and second casing 210b. Each of first casing 210a and second casing 210b has a mounting hole 415 used for attaching to and positioning rotating disc 215 inside first casing 210a and second casing 210b. Mounting hole 415 of first casing 210a and second casing 210b may be disposed on a reference axis 250 of rotating disc 215. Reference axis 250 of rotating disc 215 is offset with respect to a reference axis of first casing 210a and second casing 210b, which coincides with reference axis 235 of a first bulb holder and a second bulb holder (first bulb holder 115a and second bulb holder 115b as shown in FIG. 3).

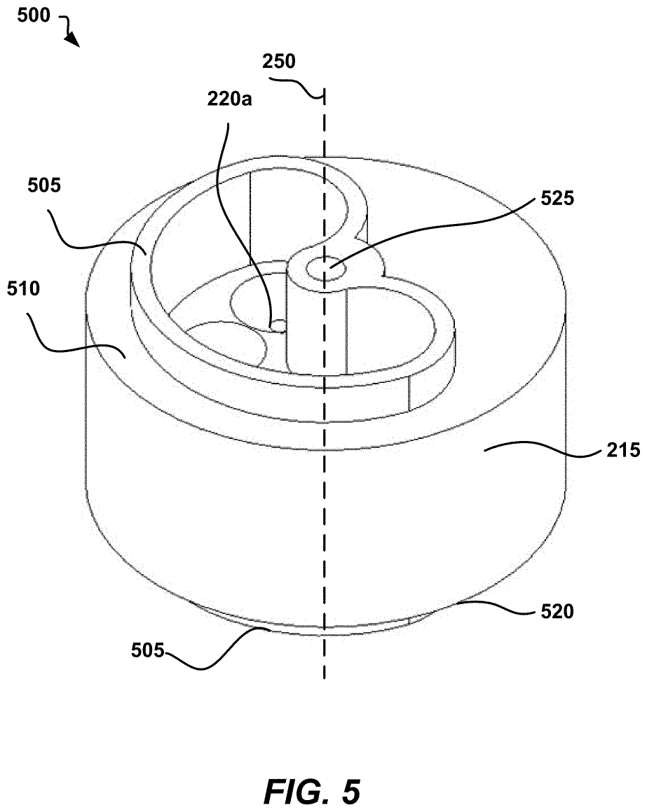

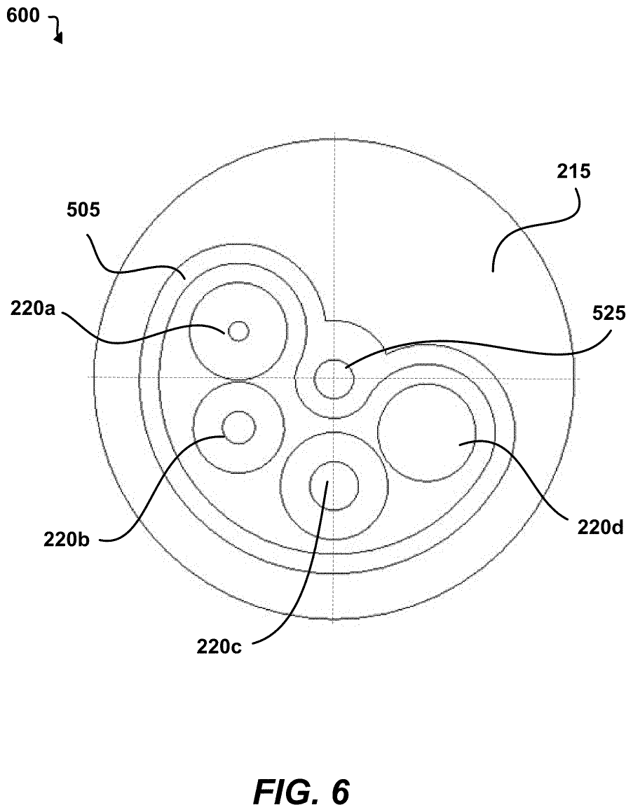

FIG. 5 is an isometric view 500 of a rotating disc 215, according to one example embodiment. FIG. 6 is a top view 600 of rotating disc 215, according to one example embodiment. FIGS. 5 and 6 show that rotating disc 215 can incorporate multiple through holes of different sizes, such as first through hole 220a, second through hole 220b, third through hole 220c, and fourth through hole 220d. Fourth through hole 220d is the largest in size and can be used for the “reset” function.

Rotating disc 215 may further have a restrictor 505. In an example embodiment, restrictor 505 may be provided on each of an upper side 510 and a bottom side 520 of rotating disc 215. Restrictor 505 may include a protrusion extending from upper side 510 and bottom side 520, respectively. Restrictor 505 may have a curved shape and may enclose first through hole 220a, second through hole 220b, third through hole 220c, and fourth through hole 220d.

Rotating disc 215 may further have a mounting hole 525 for attaching rotating disc 215 to first casing 210a and second casing 210b via mounting hole 415 of first casing 210a and second casing 210b (shown in FIG. 4). Mounting hole 525 may be disposed on a reference axis 250 of rotating disc 215.

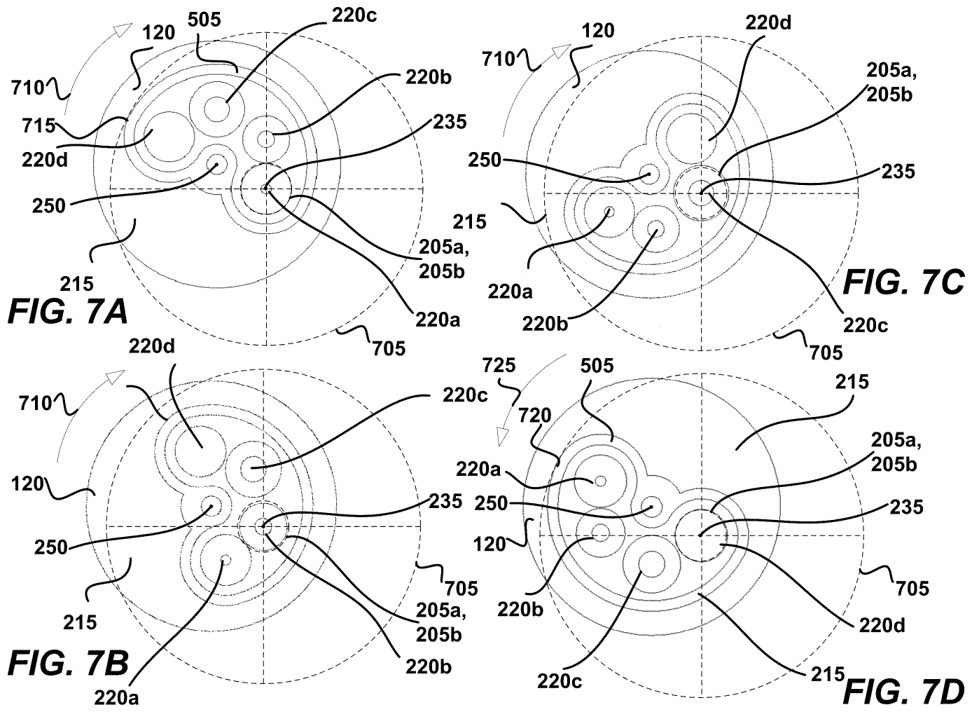

FIGS. 7A-7D are schematic diagrams showing switching between positions of a rotating disc 215 inside an adjustable hourglass mechanism to select a desired timing or a reset function, according to an example embodiment. FIGS. 7A-7D show the rotation of rotating disc 215 with respect to schematically shown inner surface 705 of side walls of first casing 210a and second casing 210b. Rotating disc 215 may be rotated around reference axis 250 of rotating disc 215. Reference axis 250 is offset with respect to reference axis 235 of a first bulb holder and a second bulb holder (first bulb holder 115a and second bulb holder 115b as shown in FIG. 3). In view of displacement of reference axis 250 with respect to reference axis 235, at least a portion of rotating disc 215 extrudes from the first bulb holder and the second bulb holder and forms a dial 120.

Restrictor 505 may restrict the rotation of rotating disc 215 inside first casing 210a and second casing 210b so that rotating disc 215 rotates between a first end position when first through hole 220a is placed between channel 205a and channel 205b (schematically shown in FIGS. 7A-7D by a dashed circle) and a second end position when fourth through hole 220d is placed between channel 205a and channel 205b. FIG. 7A shows rotating disc 215 in the first end position. In the first end position, restrictor 505 may rest, by a first curved portion 715 of restrictor 505, on inner surface 705 of side walls of first casing 210a and second casing 210b. In view of resting of first curved portion 715 on inner surface 705, rotating disc 215 can only be rotated clockwise as shown by an arrow 710 and cannot be rotated in the opposite direction. In the first end position, first through hole 220a is placed between channel 205a and channel 205b of a first bulb holder and a second bulb holder, respectively, to allow releasing a granular material from channel 205a to channel 205b through first through hole 220a, thereby releasing the granular material from a first bulb to a second bulb.

When rotated from the first end position to the second end position in a clockwise direction as shown by arrow 710, restrictor 505 may first be placed into a first intermediate position when second through hole 220b is located between channel 205a and channel 205b and then placed into a second intermediate position when third through hole 220c is located between channel 205a and channel 205b. FIG. 7B shows rotating disc 215 in the first intermediate position. In the first intermediate position, second through hole 220b is placed between channel 205a and channel 205b of a first bulb holder and a second bulb holder, respectively, to allow releasing the granular material from channel 205a to channel 205b through second through hole 220b, thereby releasing the granular material from a first bulb to a second bulb. FIG. 7C shows rotating disc 215 in the second intermediate position. In the second intermediate position, third through hole 220c is placed between channel 205a and channel 205b of a first bulb holder and a second bulb holder, respectively, to allow releasing the granular material from channel 205a to channel 205b through third through hole 220c, thereby releasing the granular material from a first bulb to a second bulb. FIG. 7D shows rotating disc 215 in the second end position. In the second end position, fourth through hole 220d is placed between channel 205a and channel 205b of a first bulb holder and a second bulb holder, respectively, to allow releasing the granular material from channel 205a to channel 205b through fourth through hole 220d, thereby releasing the granular material from a first bulb to a second bulb. In the second end position, restrictor 505 may rest, by a second curved portion 720 of restrictor 505, on inner surface 705 of side walls of the first casing and the second casing. When in the second end position, restrictor 505 can only be rotated counterclockwise as shown by an arrow 725 and cannot be rotated in the opposite direction in view of second curved portion 720 resting on inner surface 705.

Similarly, when rotated from the second end position to the first end position, restrictor 505 may first be placed into the second intermediate position when third through hole 220c is located between channel 205a and channel 205b, then placed into the first intermediate position when second through hole 220b is located between channel 205a and channel 205b, and after that placed into the first end position when first through hole 220c is located between channel 205a and channel 205b.

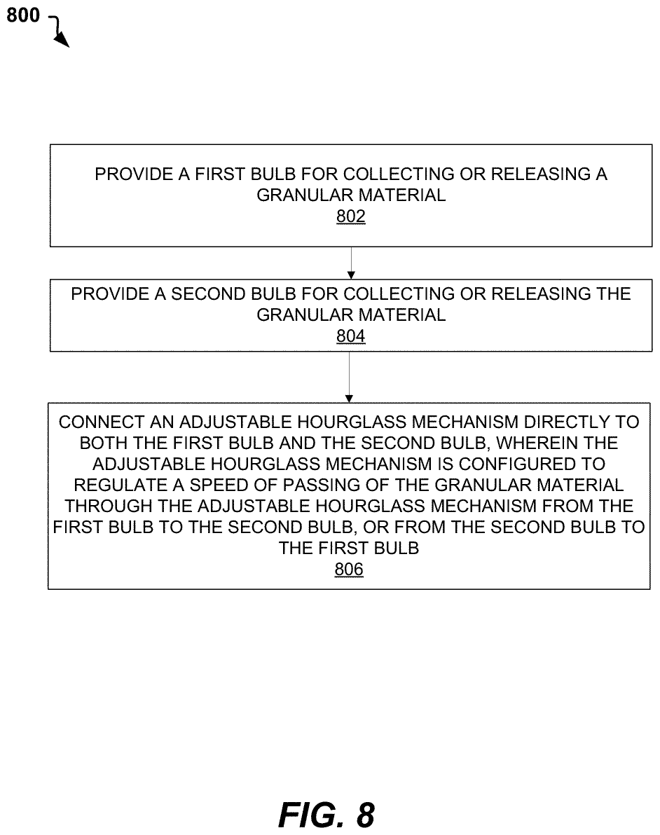

FIG. 8 is a flow chart 800 illustrating a method for producing an hourglass assembly, in accordance with an example embodiment. The method 800 may include providing a first bulb for collecting or releasing a granular material at operation 802 and providing a second bulb for collecting or releasing the granular material at operation 804. The first bulb and the second bulb can be of any suitable transparent or semi-transparent material, including, without limitation, a glass or polymer. The method 800 may further include connecting an adjustable hourglass mechanism directly to both the first bulb and the second bulb at operation 806. The adjustable hourglass mechanism may include a first bulb holder, a second bulb holder, a rotating disc, and a first casing and a second casing for the rotating disc. The first bulb holder, the second bulb holder, the rotating disc, the first casing, and the second casing can be made of any suitable material, including, without limitation, polymers, wood, metal, or any combination thereof. The adjustable hourglass mechanism may be configured to regulate a speed of passing of the granular material through the adjustable hourglass mechanism from the first bulb to the second bulb or from the second bulb to the first bulb.

Thus, an hourglass assembly and a method for producing an hourglass assembly have been described. Although embodiments have been described with reference to specific example embodiments, it will be evident that various modifications and changes can be made to these example embodiments without departing from the broader spirit and scope of the present document. Accordingly, the specification and drawings are to be regarded in an illustrative rather than a restrictive sense.

1. An hourglass assembly, comprising:
a first bulb for collecting or releasing a granular material;
a second bulb for collecting or releasing the granular material; and
an adjustable hourglass mechanism directly connected to both the first bulb and the second bulb, wherein the adjustable hourglass mechanism is configured to regulate a speed of passing of the granular material through the adjustable hourglass mechanism from the first bulb to the second bulb or from the second bulb to the first bulb, wherein the adjustable hourglass mechanism comprises:
a first bulb holder for holding the first bulb, the first bulb holder having a first end configured to connect with the first bulb and a second end configured to connect with a second bulb holder, wherein the first bulb holder has first side walls and a first internal wall arranged perpendicular to the first side walls, the first side walls and the first internal wall are forming a first hollow section and a second hollow section, the first hollow section and the second hollow section being opposite with respect to the first internal wall, the first hollow section being designed to receive the first bulb and the second hollow section being designed to receive a first casing;
the second bulb holder for holding the second bulb, the second bulb holder having a first end configured to connect with the second bulb and a second end configured to connect with the second end of the first bulb holder, wherein the second bulb holder has second side walls and a second internal wall arranged perpendicular to the second side walls, the second side walls and the second internal wall are forming a third hollow section and a fourth hollow section, the third hollow section and the fourth hollow section being opposite with respect to the second internal wall, the third hollow section being designed to receive the second bulb and the fourth hollow section being designed to receive a second casing;
the first casing located within the second hollow section between the first internal wall of the first bulb holder and a rotating disc;
the second casing located within the fourth hollow section between the second internal wall of the second bulb holder and the rotating disc,
wherein the first casing and the second casing are forming an internal space for enclosing the rotating disc; and
the rotating disc enclosed in the internal space between the first casing and the second casing.

2. (canceled)

3. The hourglass assembly of claim 1,
wherein the first casing and the second casing symmetrically face each other.

4. The hourglass assembly of claim 1, wherein the first bulb holder has a first channel extending through the first internal wall for passing of the granular material, and the second bulb holder has a second channel extending through the second internal wall for passing of the granular material.

5. The hourglass assembly of claim 4, wherein the rotating disc comprises a plurality of through holes for receiving the granular material from the first bulb via the first channel and passing the granular material to the second bulb via the second channel.

6. The hourglass assembly of claim 5, wherein a first through hole of the plurality of through holes is configured to be positioned in line with the first channel and the second channel.

7. The hourglass assembly of claim 5, wherein each of the plurality of through holes has a different diameter.

8. The hourglass assembly of claim 5, wherein a diameter of one of the plurality of through holes is equal to an inner diameter of the first channel and an inner diameter of the second channel; and
wherein a diameter of each further through hole of the plurality of through holes is smaller than the inner diameter of the first channel and the inner diameter of the second channel.

9. The hourglass assembly of claim 7, wherein a reference axis of the first bulb and a reference axis of the second bulb coincide; and
wherein a reference axis of the rotating disc is offset with respect to the reference axis of the first bulb and the second bulb.

10. The hourglass assembly of claim 9, wherein each of the first bulb holder and the second bulb holder has a recess in the first side walls and the second side walls, wherein at least a portion of the rotating disc projects outwards through the recess.

11. The hourglass assembly of claim 10, wherein the rotating disc is configured to rotate around the reference axis of the rotating disc in response to applying a sideward force by a user to the portion of the rotating disc projecting outwards through the recess.

12. The hourglass assembly of claim 11, wherein a second through hole of the plurality of holes is configured to move to be positioned in line with the first channel and the second channel in response to the rotation of the rotating disc around the reference axis of the rotating disc.

13. A method for producing an hourglass assembly, the method comprising:
providing a first bulb for collecting or releasing a granular material;
providing a second bulb for collecting or releasing the granular material; and
connecting an adjustable hourglass mechanism directly to both the first bulb and the second bulb, wherein the adjustable hourglass mechanism is configured to regulate a speed of passing of the granular material through the adjustable hourglass mechanism from the first bulb to the second bulb or from the second bulb to the first bulb, wherein the adjustable hourglass mechanism comprises:
a first bulb holder for holding the first bulb, the first bulb holder having a first end configured to connect with the first bulb and a second end configured to connect with a second bulb holder, wherein the first bulb holder has first side walls and a first internal wall arranged perpendicular to the first side walls, the first side walls and the first internal wall are forming a first hollow section and a second hollow section, the first hollow section and the second hollow section being opposite with respect to the first internal wall, the first hollow section being designed to receive the first bulb and the second hollow section being designed to receive a first casing;
the second bulb holder for holding the second bulb, the second bulb holder having a first end configured to connect with the second bulb and a second end configured to connect with the second end of the first bulb holder, wherein the second bulb holder has second side walls and a second internal wall arranged perpendicular to the second side walls, the second side walls and the second internal wall are forming a third hollow section and a fourth hollow section, the third hollow section and the fourth hollow section being opposite with respect to the second internal wall, the third hollow section being designed to receive the second bulb and the fourth hollow section being designed to receive a second casing;
the first casing located within the second hollow section between the first internal wall of the first bulb holder and a rotating disc;
the second casing located within the fourth hollow section between the second internal wall of the second bulb holder and the rotating disc,
wherein the first casing and the second casing are forming an internal space for enclosing the rotating disc; and
the rotating disc enclosed in the internal space between the first casing and the second casing.

14. (canceled)

15. The method of claim 13,
wherein the first casing and the second casing symmetrically face each other.

16. The method of claim 15, wherein the first bulb holder has a first channel extending through the first internal wall for passing of the granular material, and the second bulb holder has a second channel extending through the second internal wall for passing of the granular material.

17. The method of claim 16, wherein the rotating disc comprises a plurality of through holes for receiving the granular material from the first bulb via the first channel and passing the granular material to the second bulb via the second channel.

18. The method of claim 17, wherein a first through hole of the plurality of through holes is positioned in line with the first channel and the second channel.

19. The method of claim 13, wherein a reference axis of the first bulb and a reference axis of the second bulb coincide; and
wherein a reference axis of the rotating disc is offset with respect to the reference axis of the first bulb and the second bulb.

20. An hourglass assembly, comprising:
a first bulb for collecting or releasing a granular material;
a second bulb for collecting or releasing the granular material; and
an adjustable hourglass mechanism directly connected to both the first bulb and the second bulb, wherein the adjustable hourglass mechanism is configured to regulate a speed of passing of the granular material through the adjustable hourglass mechanism from the first bulb to the second bulb or from the second bulb to the first bulb, wherein the adjustable hourglass mechanism comprises:
a first bulb holder for holding the first bulb, the first bulb holder having a first end configured to connect with the first bulb and a second end configured to connect with a second bulb holder, wherein the first bulb holder has first side walls and a first internal wall arranged perpendicular to the first side walls, the first side walls and the first internal wall are forming a first hollow section and a second hollow section, the first hollow section and the second hollow section being opposite with respect to the first internal wall, the first hollow section being designed to receive the first bulb and the second hollow section being designed to receive a first casing;
the second bulb holder for holding the second bulb, the second bulb holder having a first end configured to connect with the second bulb and a second end configured to connect with the first bulb holder, wherein the second bulb holder has second side walls and a second internal wall arranged perpendicular to the second side walls, the second side walls and the second internal wall are forming a third hollow section and a fourth hollow section, the third hollow section and the fourth hollow section being opposite with respect to the second internal wall, the third hollow section being designed to receive the second bulb and the fourth hollow section being designed to receive a second casing;
the first casing located within the second hollow section between the first internal wall of the first bulb holder and a rotating disc;
the second casing located within the fourth hollow section between the second internal wall of the second bulb holder and the rotating disc,
wherein the first casing and the second casing are forming an internal space for enclosing the rotating disc; and
the rotating disc enclosed in the internal space between the first casing and the second casing;
wherein a reference axis of the first bulb and a reference axis of the second bulb coincide; and
wherein a reference axis of the rotating disc is offset with respect to the reference axis of the first bulb and the second bulb;
wherein the rotating disc comprises a plurality of through holes for receiving the granular material from the first bulb via a first channel and passing the granular material to the second bulb via a second channel, wherein a first through hole of the plurality of through holes is positioned in line with the first channel and the second channel;
wherein each of the first bulb holder and the second bulb holder has a recess in the first side walls and the second side walls, wherein at least a portion of the rotating disc projects outwards through the recess;
wherein the rotating disc is configured to rotate around the reference axis of the rotating disc in response to applying a sideward force by a user to the portion of the rotating disc projecting outwards through the recess; and
wherein a second through hole of the plurality of holes is configured to move to be positioned in line with the first channel and the second channel in response to the rotation of the rotating disc around the reference axis of the rotating disc.
